(19) United States
(12) Patent Application Publication
(10) Pub. No.: US 2015/0365446 A1
(43) Pub. Date: Dec. 17, 2015

(54) Process and result of real-time/live doodling that engages more than one user at the same time on an application or software that uses internet for connection

(71) Applicant: Shahzeen Rehman, Scottdale, GA (US)

(72) Inventor: Shahzeen Rehman, Scottdale, GA (US)

(21) Appl. No.: 14/302,513

(22) Filed: Jun. 12, 2014

(51) Int. Cl. H04L 29/06; G06F 3/0482; G06F 3/0484

(52) U.S. Cl. CPC H04L 65/403; G06F 3/04842; G06F 3/0482

(57) ABSTRACT

An Internet application or software has many features to connect and share data with your family and peers.

One of the feature that does not exist at this time is the process of live doodling which enables two users to doodle in real time. We want to patent the idea of real-time/live doodling and its result which will provide users with a way to interact in real time. Example User A and User B are using an internet application or software. They select an option of live doodle from the menu and a screen is opened. User A and User B can write or draw in real time which means User A can see what User B is doing and vice versa. The users can also engage in the activity simultaneously where each one can see what the other user is writing or drawing.

Patent the process of real-time/live doodling and its result on an Internet software or application.

Currently, there are no applications or software that provides users with the option real-time/live doodling. Real-time/live doodling on an application or software will provide users with better interactions and will allow them to write, draw and engage on an application or software in real time.

1. Protect and patent the process of real time/live doodle and its result on any application Or software that uses internet for connection.
